(19) United States
(12) Patent Application Publication
(10) Pub. No.: US 2007/0174272 A1
(43) Pub. Date: Jul. 26, 2007

(54) Facial Recognition in Groups

(75) Inventors: Marc Stanley Carter, Southampton (GB); James Steven Luke, Cowes Isle of Wight (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/424,571

(22) Filed: Jun. 16, 2006

(30) Foreign Application Priority Data
Jun. 24, 2005 (GB) 0512869.9

(51) Int. Cl. G06F 17/30

(52) U.S. Cl. 707/5

(57) ABSTRACT

A system for group facial recognition includes a target extractor for extracting target images from a scene image; a target image classifier for comparing a target image to a database of known identities and allocating classification scores for identities; a relationship database providing relationship scores between known identities; and means for applying the relationship scores to the classification scores to improve classification of a target image. Two or more target images are extracted from a scene image and it is determined that a first target image is one of a first set of identities, each with a classification score, and that a second target image is one of a second set of identities, each with a classification score. A relationship score is determined for each of the first set of identities giving the relationship to one or more of the second set of identities. The relationship score is applied to the classification score for the first target image.

### BACKGROUND OF THE INVENTION

The present invention relates to the field of facial recognition in groups, and more particularly, to parallel facial recognition of targets through relationships.

There are many documented researches and solutions on the concept of detecting faces within a photograph or moving image. There are also many methods of facial detection through different visual structures and cues. All methods of facial detection work, to a greater or lesser degree, on the idea of a probabilistic match between the observed features and the stored profile of a specific person.

### BRIEF SUMMARY OF THE INVENTION

According to a first aspect of the present invention, a method for facial recognition in groups comprises extracting at least two target images from a scene image, determining that a first target image is one of a first set of identities, determining that a second target image is one of a second set of identities, generating a classification score that the first target image corresponds to each of the first set of identities, determining a relationship score that an identity of the first set of identities is related to an identity of the second set of identities, and applying the relationship score to the classification score for the first target image.

According to another aspect of the present invention, a system for facial recognition in groups comprises a target extractor for extracting target images from a scene image, a target image classifier for comparing a target image to a database of known identities and allocating classification scores for identities, a relationship database providing relationship scores between known identities, and means for applying the relationship scores to the classification scores to improve classification of a target image.

According to yet another aspect of the present invention, a computer program product for facial recognition in groups comprises a computer usable medium having computer useable program code embodied therewith. The computer useable program code comprises computer usable program code configured to extract at least two target images from a scene image, computer usable program code configured to determine that a first target image is one of a first set of identities, computer usable program code configured to determine that a second target image is one of a second set of identities, computer usable program code configured to generate a classification score that the first target image corresponds to each of the first set of identities, computer usable program code configured to determine a relationship score that an identity of the first set of identities is related to an identity of the second set of identities, and computer usable program code configured to apply the relationship score to the classification score for the first target image.

Other aspects and features of the present invention will become apparent to those ordinarily skilled in the art or science to which it pertains upon review of the following description in conjunction with the accompanying Figures.

### BRIEF DESCRIPTION OF THE SEVERAL VIEWS OF THE DRAWINGS

FIG. 1 is a schematic diagram of a scene image with target images;

FIG. 2 is a block diagram showing the components of a system in accordance with the present invention;

FIG. 3 is a flow diagram of a method in accordance with the present invention;

FIG. 4 is a flow diagram of a first embodiment of a data fusion algorithm in accordance with an aspect of the present invention; and

FIG. 5 is a flow diagram of a second embodiment of a data fusion algorithm in accordance with an aspect of the present invention.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-usable or computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flow chart and/or block diagram block or blocks.

The method and system described below is essentially a sensor data fusion solution. It is taking information from multiple sources and using that information to improve the quality of a classification process. In particular, first level classifications of a series of targets by a conventional facial recognition system are fused with probability data that describes historical knowledge of the targets in order to generate a second level classification with improved accuracy.

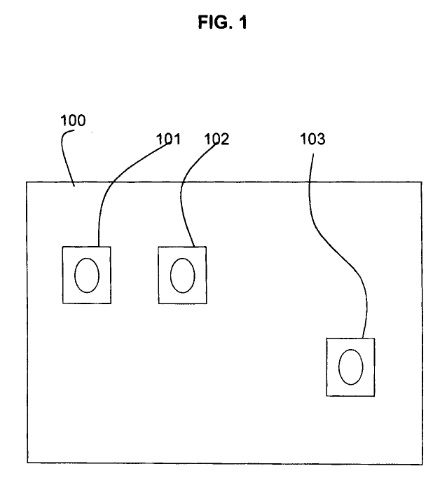

FIG. 1 shows a scene image 100 with three target images 101, 102, 103 shown within the scene image 100. The target images 101, 102, 103 are facial images of targets to be identified.

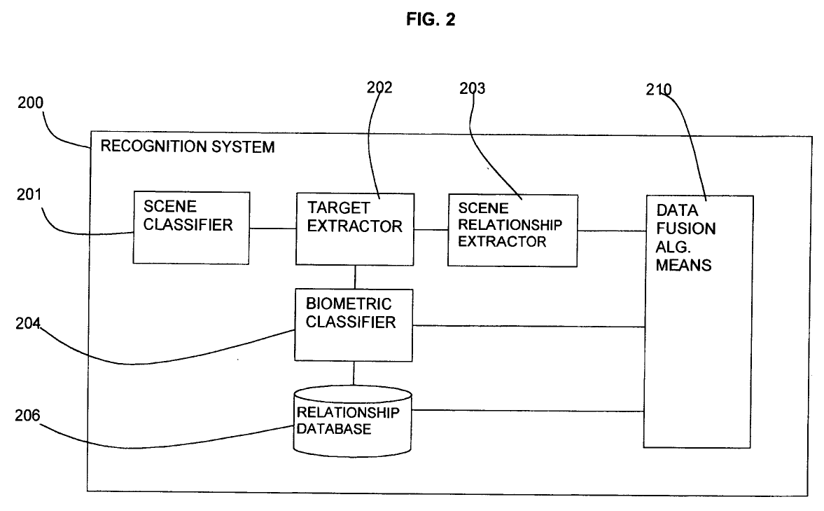

A system of facial recognition is described with reference to FIG. 2. FIG. 2 is a schematic block diagram showing a recognition system 200. The components of the recognition system 200 may be local to a single computer system or may be distributed across different computer systems, possibly via network communications. The system 200 includes the components of a scene classifier 201, a target extractor 202, a scene relationship extractor 203, a biometric classifier 204 and a relationship database 206. A data fusion algorithm module 210 applies the outputs of the components. The scene classifier 201 analyses scene images to determine the type of scene they represent. A target extractor 202 extracts images of the faces of individual targets from the scene. The technique used by the target extractor 202 is dependent on the type of scene as classified by the scene classifier 201.

A scene relationship extractor 203 is also specialized to the type of scene as classified by the scene classifier 201. The scene relationship extractor 203 constructs a matrix of scene relationships between target images as extracted by the target extractor 202. A biometric classifier 204 determines biometric features from the target images extracted by the target extractor 202 and generates a target classification probability matrix for known identities in an identity database. A relationship database 206 stores known relationships between identities. This may be the same database as the identity database. A data fusion algorithm module 210 applies outputs from the biometric classifier 204 and the relationship database 206, and, optionally, the scene relationship extractor 203 to provide a result. The result may be a classification probability of a target image to one or more identities or may be the identity with the highest probability.

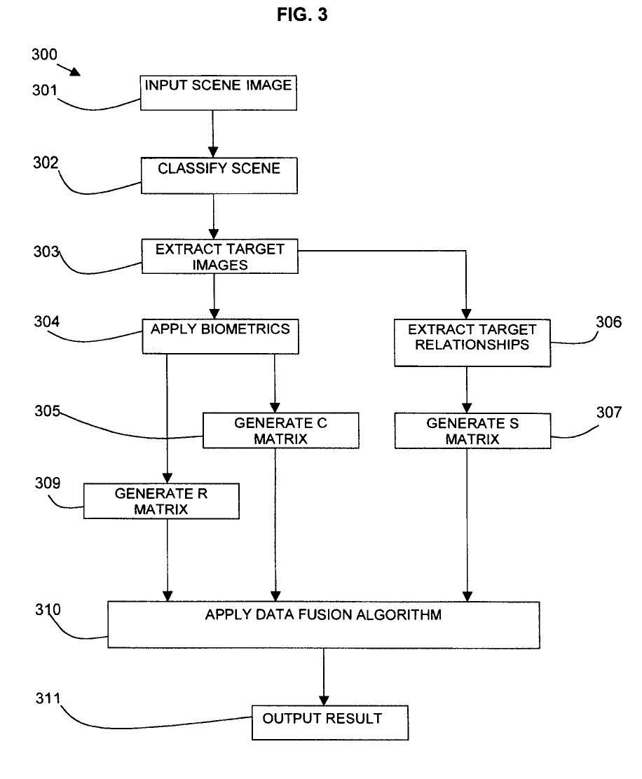

Referring to FIG. 3, a flow diagram 300 shows a method of facial recognition using relationships using the system 200 of FIG. 2. A scene image is input 301 and the scene is classified 302 as a type of scene. Target images are extracted 303 from the input scene image and biometric methods are applied 304 to the target images. This generates 305 a target classification probability matrix C which gives the likelihood, Cin, of a relationship between target image Ii and person Pn for all people in an identity database 105. Relationships between target images are extracted 306 from the input scene image and a scene relationship probability matrix S is generated 307 giving the likelihood, Sij, of a relationship between target images Ii and Ij for all target images in the scene. A relationship database 106 provides a relationship probability matrix R 309 giving the likelihood, Rnm, of a relationship between people Pn and Pm for all people in the database. The three probability matrices 305, 307, 309 for the target classification probability Cin, relationship probability Rnm, and, optionally, the scene relationship probability Sij are inputs into a data fusion algorithm 310.

Two embodiments of a data fusion algorithm are described in detail below. The data fusion algorithm provides an output 311 giving a classification probability of a target image to an identity strengthened by the relationships with other target images in the input image. The scene relationship probability matrix 309 may be used to filter/order the number of potential tests or it may be use

Scene images (such as that shown in FIG. 1) are analysed to determine the type of scene they represent. For example, a scene image may be one of the following:

1. A crowd photograph showing many faces. The co-existence of two faces in such a photograph is not necessarily sufficient to determine a relationship. It is necessary to apply further analysis to determine whether the two faces are “together”.

2. A formal group photograph. For example, showing a team, school or the employees of a company. Such an image may include a limited number of people arranged in a particular formation with all faces clearly visible. The co-existence of two faces in such an image is sufficient to determine a relationship (i.e. attending the same school).

3. A surveillance photograph showing a small number of people. Such an image may include a limited number of people all facing in different directions. The co-existence of faces in such a photograph is probably sufficient to assume a relationship.

4. A social photograph showing a group of people. Such an image may include foreground faces who are the main subjects of the image together with background faces who may or may not be related. The co-existence of the main subjects is sufficient to assume a relationship, however further information is required to determine the significance of the background faces.

For a particular system, scene classification may not be necessary as all scene images may come from the same system (for example, from security cameras). The described embodiment includes a system, a scene classification components, for analysing the generic scene to determine the type of scene before calling specialised classifiers appropriate to the type of scene. There are a number of ways a scene classification component may classify a type of scene. The following are some examples known in the art.

1. Using a clustering algorithm to identify similarities between scene images.

2. Training a classifier (e.g. a neural network) to identify particular types of scene image. Such a network would take many measurements of the scene image as it's inputs and use well-known back propagation techniques to deliver a classification based upon it's previous training. Example inputs could include colour levels, resolution, proportion of skin tone/sky/grass, number/size/location of faces identified.

3. Manually defining an algorithm to identify different types of scene image. This could be based on extracting all the faces identified in the scene image (as described in the target extraction component below), and counting those target images and their respective sizes relative to the overall scene image size. The resulting parameters could then determine whether this was a large crowd photo or three friends immediately in front of the camera.

A target extraction component is specialized to the type of scene image of interest. There are multiple implementations of this component and the scene classification component calls the most appropriate for the particular type of scene image. The function of this component is to extract from a scene image the faces of individual targets (such as the target images 101, 102, 103 of FIG. 1). This is well known in the art. Implementations commonly incorporate shape detection, color detection, and pattern matching of the shadows on a face.

The function of the biometric classifier is to extract biometric features from the target frames identified by the target extraction component and to generate for every known identity the probability of a match. A target classification probability matrix C is created which gives the likelihood, Cin, of a relationship between target image Ii and person Pn for all people in an identity database. A biometric classifier measures and statistically analyses biological data from a target image. For example, facial patterns and measurements may be matched to measurements of known identities. Information provided from the target image is analyzed and compared to a database that stores the biometric data of known identities for comparison. The classifier may identify specific points of data as match points which are processed to provide a probability of a match with a known identity.

Relationships can be determined using the relationship database to generate a probability matrix describing the likelihood that two identities are related. The relationship probability matrix gives the likelihood, Rnm, of a relationship between people Pn and Pm for all people in a database. This matrix could be generated in different ways as follows:

Based on known relationships using arbitrary values for different relationships (membership of a club, same school, family member, close friends, etc.).

Manually using analyzed historical data.

Semi-automatically using a combination of manual and machine classification techniques including the previous output of this same algorithm (i.e. the number of times the people have been seen together).

Motion tracking may be used to track target faces and their proximity/direction over a period of time to discern relationships. For example, an airport lounge has many large groups of people which cannot be easily subdivided into a single scene image. A way to discern relationships may be to monitor which groups break off the main group (for example, if one person stops to do something, the rest of their group will wait for them).

As with the target extraction component, the scene relationship extraction component is also specialized to the type of scene image of interest. The function of the scene relationship extraction component is to construct a matrix of scene relationships between target images identified in the scene image. A scene relationship probability matrix S is generated giving the likelihood, Sij, of a relationship between target images Ii and Ij for all target images in the scene image. Some examples are as follows:

In a social photograph, the probability of a relationship between each of the foreground subjects may be set to a particular value, whilst the probability of a relationship between a foreground subject and a background subject will be set to a much lower value.

In a team photograph, the probability of a relationship between each of the targets can be set to a particular value.

In a crowd photograph, a proximity measure may be applied to a probability distribution to determine the likelihood of a relationship.

In a seated sporting crowd, the proximity relationship can be extended to favor people in the same row.

A and B are two football supporters who attend matches together and support the same team. C is a supporter of another team. The identities of A, B and C are stored in an identity database. Target classification probabilities are the output of an image classifier. In this example, it is assumed that the image processing system extracts two target images (Image 1 and Image 2) and assigns the following classification probabilities, where Cin is the likelihood of a relationship between target image Ii and person Pn:

| | |
|---|---|
| C1A = 0.9 | C2A = 0.1 |
| C1B = 0.1 | C2B = 0.6 |
| C1C = 0.2 | C2C = 0.8 |

| | A | B | C |
|---|---|---|---|
| Image 1 | 0.9 | 0.1 | 0.2 |
| Image 2 | 0.1 | 0.6 | 0.8 |

This shows that target Image 1 is almost certainly A whilst target Image 2 could be either B or C.

Relationship probabilities determine the probability that two or more individuals will be seen together. The relationship probability gives the likelihood, Rnm, of a relationship between people Pn and Pm. In this example, the relationships between A, B and C are:

RAB=RBA=0.85. It is logical to assume relationships are not directional.

RAC = 0.1
RBC = 0.0

| | A | B | C |
|---|---|---|---|
| A | 0.0 | 0.85 | 0.1 |
| B | 0.85 | 0.0 | 0.0 |
| C | 0.1 | 0.0 | 0.0 |

These figures are based on previous observations of A, B and C being seen together.

Scene relationship probabilities values are extracted from a captured scene using specialised algorithms. A different algorithm may be used for scenes inside a football stadium as opposed to one used for scenes at a railway station. A group of five people walking as part of much larger crowd through a railway station may be grouped with one or two behind or in front. The same group seated in their seats in the stadium may be seated in a row. Similarly, inside a stadium there may be a partition separating opposing fans. In such a scenario, A and C in the example, may be seen in close proximity on either side of the partition. The scene probability algorithm takes such factors into account. For the purposes of this example, assume A and B are walking through a railway station together. A probability value may be assigned using a standard normal distribution based on their separation. A more sophisticated system could use a multi-dimensional distribution based upon separation and additional factors such as direction or position.

For moving video footage, there is a value in fusing over time. This involves measuring the mean separation, over a number of images, between each extracted entity. Such an approach would take into account people becoming separated and then re-joining, the group dynamics (for example, one member of a group dropping back to talk to another member). To achieve this it would be necessary to track each entity to ensure that target Image 1 in Scene 1 is definitely target Image 1 in Scene 2. Once determined, the separation values are mapped onto probabilities using a normal distribution. The scene relationship probability is the likelihood, Sij, of a relationship between target images Ii and Ij for all target images in the scene.

For this example,
S12=0.8

It is also possible that the scene relationship extractor extracted a third image (target Image 3 which is of a subject D) and assigned S13=0.7. For the purposes of this example, it is assumed RAD=RBD=0.05 and C3D=0.9. In summary, this (gives the three probability matrices as follows:

| | | | |
|---|---|---|---|
| A | B | C | D |

Classification probability matrix C:

| | | | | |
|---|---|---|---|---|
| Image 1 | 0.9 | 0.1 | 0.2 | 0.1 |
| Image 2 | 0.1 | 0.6 | 0.8 | 0.2 |
| Image 3 | 0.2 | 0.1 | 0.2 | 0.9 |

Relationship probability matrix R:

| | | | | |
|---|---|---|---|---|
| A | 0.0 | 0.85 | 0.1 | 0.05 |
| B | 0.85 | 0.0 | 0.0 | 0.05 |
| C | 0.1 | 0.0 | 0.0 | 0.0 |
| D | 0.05 | 0.05 | 0.0 | 0.0 |

Scene probability matrix S.

| | Image 1 | Image 2 | Image 3 |
|---|---|---|---|
| Image 1 | 0.0 | 0.8 | 0.7 |
| Image 2 | 0.8 | 0.0 | 0.6 |
| Image 3 | 0.7 | 0.6 | 0.0 |

The data fusion algorithm takes as inputs:
1. The output of the biometric classifier detailing the probability of a match for each known identity.
2. The relationship matrix.
3. Optionally, the scene relationship probabilities for each target in the image.

Most of the measurements that comprise the matrices are not true probabilities but simply a score. A mapping function can convert the output score of the AI classification engines, using an upper bound, to resemble a sigmoid activation function with values from 0 to 1. This shape of curve allows thresholding of classification decisions to be endogenous to the system. This removes the need to explicitly check each output score against threshold values.

Two embodiments of possible data fusion algorithms are described. A first embodiment is a probabilistic method and a second embodiment is an iterative method. Both methods have the option of including the scene relationship score or not. This is shown in the probabilistic embodiment but not in the iterative embodiment. Both methods map their classification outputs to a range of 0 to 1 but treat them differently (as probabilities or as scores). Both methods have the option of mapping their values across a sigmoid “activation” function, although this makes more sense in the probabilistic algorithm. The sigmoid function essentially makes the 0 to 1 score more partisan—more black and white with less grey in the middle.

The probabilistic method returns a matrix of classification probabilities C′, for the target images in the scene. The iterative method returns the potential situation with the highest final score (T). In practice, it could present the full list of potential situations ordered by T. The figures used in the worked example above have been applied in each embodiment for illustrative purposes.

The first embodiment of the data fusion algorithm in the form of the probabilistic method is now described. In the first embodiment, the final target classification probability, C′in, of a target image is made up of two parts, the original classification probability and the weighted probability of a relationship with others in the scene.
C′in=Cin×Pin

where:

Cin is the original target classification probability;

Pin is the combined probability of a relationship with others in the image.

The probability of a relationship (Pin), given that target image i is person n, is the product of:

the probabilities that target image i is related to target image j, (Sij);

there is a relationship between people n and m (Rnm); and

that target image j resembles person m (Cjm) for all other people in the database.

An example of calculating Pin for an image with two targets (i and j) only:
Pin=Sij max m (Rnm Cjm)
where, the max function is essentially the maximum across all m other people.

To extend this to target images with more than one possible relationship:
Pin=max j (Sij max m (Rnm Cjm))

Using the matrices above gives the relationship matrix P:

| | A | B | C | D |
|---|---|---|---|---|
| I1 | 0.41 | 0.12 | 0.01 | 0.02 |
| I2 | 0.07 | 0.61 | 0.07 | 0.04 |
| I3 | 0.31 | 0.54 | 0.06 | 0.03 |

And the final classification C′:

| | | | | |
|---|---|---|---|---|
| I1 | 0.37 | 0.01 | 0.00 | 0.00 |
| I2 | 0.01 | 0.37 | 0.06 | 0.01 |
| I3 | 0.06 | 0.05 | 0.01 | 0.03 |

This classification be used in conjunction with the original one dependant on the desired situational usage and how strongly groups are to be weighted. The use of the maximum function is simplification of the “natural thought process” since it implies that one strong relationship in the image is as good as two. This does not limit it's ability to account for groups of larger than two as each image individually only has to have a single strong relationship to the rest of the scene. An affordance of this method is it's ability to discover secondary relationships (where A and C were not directly linked, but share B in common). An example of this would be where classification C1A is raised by relationship by relationship RAB, and also classification C3C is raised by relationship RBC, even though relationship RAC was very low.

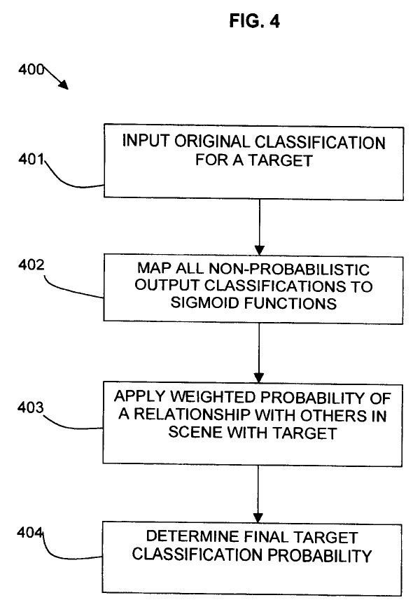

FIG. 4 is a flow diagram showing the method 400 of the first embodiment of a data fusion algorithm. At step 401 the original classification for a target is input. At step 402, all non-probabilistic output classifications are mapped to sigmoid functions. At step 403, a weighted probability of a relationship with others in the scene with the target is applied. At step 404, the final target classification probability is determined.

The second embodiment of the data fusion algorithm in the form of the iterative method is now described. In the second embodiment, the fusion algorithm is weighted between the two elements of target image classification and relationship. It should be noted that the notation here is not related to that of the first embodiment. In this embodiment, the output scores of classification components are not mapped onto probabilistic functions. Therefore, in the second embodiment, a fusion algorithm is used where the overall score given to the association of a target identity with a face in an image comprises two elements: the image classification element and the relationship element. Each element is scaled down into a range of 0 to 1. These two elements are then added together in an 80:20 ratio. Assuming that a scene image includes two target images (I1 and I2), the image classification element is the average of the individual classification scores.

1. Both I1 and I2 are allocated a series of scores for each target in the database by the image classifier. This effectively gives two matrices:
[C11, C12, . . . C1n] and
[C21, C22, . . . C2m]

These matrices indicate that I1 has been potentially matched against n possible targets whilst I2 has been potentially matched against m possible targets. It should be noted that it is possible that both I1 and I2 have been potentially matched against the same target. This (impossible) match will be removed during processing. The two matrices in (1) above give a possible n.m match pairs.

2. Iterate through each possible match pair and extract the relationship score (i.e. target 1 seen with target 3) from the relationship matrix. This score may be multiplied by the scene score to take into account the likelihood that the two faces are actually together, but will not be here. For example, if target 1 is always seen with target 2 then the relationship matrix would give a maximum score of 1.0; if the scene score is only 0.5 then the final relationship score would be 0.5.

A probability, Tnm, is then constructed for each possible combination of classifications and relationship between the respective targets. This means in a scene comprising two target faces, each image classification is weighted evenly, giving:

3. The results, based upon the numbers in the previous example, would be a table including the following lines:

| | | | | | |
|---|---|---|---|---|---|
| Image I1 = A | 0.9 | Image I2 = B | 0.6 | RAB = 0.85 | TAB = 0.77 |
| Image I1 = A | 0.9 | Image I2 = C | 0.8 | RAC = 0.1 | TAC = 0.7 |
| Image I1 = A | 0.9 | Image I2 = D | 0.2 | RAD = 0.05 | TAD = 0.45 |

The scenario with the highest Tnm score across all n and m is the final classification decision (i.e. Final result T′=max n,m(Tnm)). In this example, the final output would be a decision that Image I1=A and Image I2=B. The approach outlined above could be scaled up to work on scenarios where there are more than two faces in a scene image simply be iterating through all possible pairings and also by including groups larger than 2. In this way it it can be made to find the largest relationship sets in the scene.

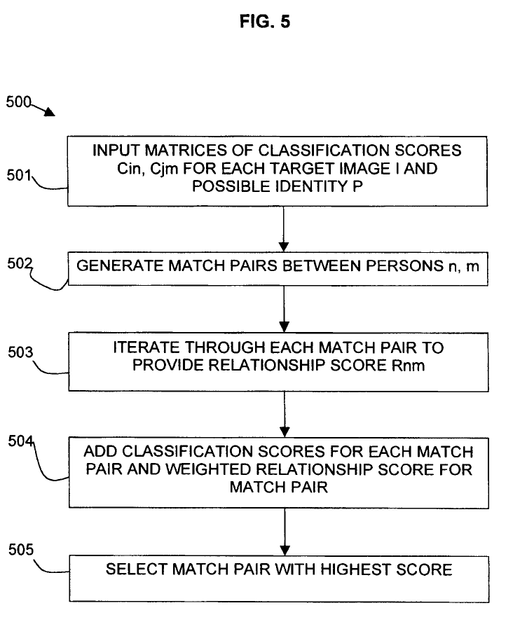

FIG. 5 is a flow diagram 500 showing the steps of the second embodiment of the data fusion algorithm. Matrices for the classification scores for each target image I for possible identities P are input 501. Match pairs of possible identities are generated 502. Iterate through the match pairs 503 to provide relationship scores for each match pair. Add the classification scores for each image of a match pair and a weighted relationship score to provide a match pair score 504. Select the match pair with the highest score as the two identities 505.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for facial recognition in groups, comprising:
extracting at least two target images from a scene image;
determining that a first target image is one of a first set of identities;
determining that a second target image is one of a second set of identities;
generating a classification score that the first target image corresponds to each of the first set of identities;
determining a relationship score that an identity of the first set of identities is related to an identity of the second set of identities; and
applying the relationship score to the classification score for the first target image.

2. A method as claimed in claim 1, wherein applying the relationship score to the classification score for the first target image comprises applying a combined relationship score with at least one other possible identity in the scene image.

3. A method as claimed in claim 2, wherein the combined relationship score is a probability of a first target image being related to at least one of the second set of identities.

4. A method as claimed in claim 2, wherein for an identity of the first set of identities, the combined relationship score is determined by:
generating a classification score that the second target image corresponds to each of the second set of identities;
applying the relationship score between the identity of the first set of identities and each of the identities of the second set of identities; and
determining the maximum.

5. A method as claimed in claim 1, wherein applying the relationship score to the classification score for the first target image comprises:
generating a classification score that the second target image corresponds to each of the second set of identities;
iterating though each possible match pair of first and second identities and extracting the relationship score for each match pair;
averaging the classification scores for the first and second target image of a match pair and applying the relationship score for the match pair; and
selecting the highest scoring match pair.

6. A method as claimed in claim 5, wherein the method is applied to more than two target images by iterating though all possible combinations.

7. A method as claims in claim 1, wherein the relationship score is weighted.

8. A method as claimed in claim 1, wherein the classification score that a target image corresponds to each of a set of identities is generated by applying biometrics to the target image.

9. A method as claimed in claim 1, wherein the relationship score is based on known relationships between identities.

10. A method as claimed in claim 1, further comprising classifying the scene image to determine a process of target extraction.

11. A method as claimed in claim 1, wherein a scene relationship score is generated between target images based on the relationship between target images in the scene image, wherein the scene relationship score is applied to the classification score for a target image.

12. A method as claimed in claim 1, wherein the method provides a result of the classification of a target image as an identity with the highest classification score.

13. A method as claimed in claim 1, wherein the method provides a result of a plurality of adapted classification scores for a target image to be each of the set of identities.

14. A method as claimed in claim 1, wherein the classification outputs are mapped across at least one of a cumulative distribution function and sigmoid function.

15. A system for facial recognition in groups, comprising:
a target extractor for extracting target images from a scene image;
a target image classifier for comparing a target image to a database of known identities and allocating classification scores for identities;
a relationship database providing relationship scores between known identities; and
means for applying the relationship scores to the classification scores to improve classification of a target image.

16. A system as claimed in claim 15, wherein the target image classifier is a biometrics classifier and applies biometric tests to a target image in the form of a facial image and compares the results with biometric results for known identities.

17. A system as claimed in claim 17, wherein the relationship database stores details of relationships based on at least one of known relationships and analyzed historical data.

18. A system as claimed in claim 17, further comprising a scene classifier to determine the type of scene of the scene image.

19. A system as claimed in claim 15, further comprising a scene relationship extractor for generating a scene relationship score between target images based on the relationship between target images in the scene image, wherein the means for applying the relationship scores to the classification scores also applies the scene relationship scores.

20. A computer program product for facial recognition in groups, said computer program product comprising:
a computer usable medium having computer useable program code embodied therewith, the computer useable program code comprising:
computer usable program code configured to extract at least two target images from a scene image;
computer usable program code configured to determine that a first target image is one of a first set of identities;
computer usable program code configured to determine that a second target image is one of a second set of identities;
computer usable program code configured to generate a classification score that the first target image corresponds to each of the first set of identities;
computer usable program code configured to determine a relationship score that an identity of the first set of identities is related to an identity of the second set of identities; and
computer usable program code configured to apply the relationship score to the classification score for the first target image.

21. A computer program product as claimed in claim 20, wherein the computer usable program code configured to apply the relationship score to the classification score for the first target image comprises computer usable program code configured to apply a combined relationship score with other possible identities in the scene image.

22. A computer program product as claimed in claim 21, wherein the computer usable program code configured to apply the relationship score to the classification score for the first target image comprises:
computer usable program code configured to generate a classification score that the second target image corresponds to each of the second set of identities;
computer usable program code configured to iterate though each possible match pair of first and second identities and extract the relationship score for each match pair;
computer usable program code configured to average the classification scores for the first and second target image of a match pair and applying the relationship score for the match pair; and
computer usable program code configured to select the highest scoring match pair.

23. A computer product as claimed in claim 20, further comprising computer usable program code configured to generate a scene relationship score between target images based on the relationship between target images in the scene image, and computer usable program code configured to apply the scene relationship score to the classification score for a target image.
